(19) United States
(12) Patent Application Publication
(10) Pub. No.: US 2008/0077679 A1
(43) Pub. Date: Mar. 27, 2008

(54) PROGRAM GENERATION BASED ON USER PLAYBACK INFORMATION

(76) Inventors: M. Ali BAWANY, Richardson, TX (US); Paul Bouchier, Richardson, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/535,673

(22) Filed: Sep. 27, 2006

(51) Int. Cl. G06F 15/177; G06F 15/16

(52) U.S. Cl. 709/220; 709/231

(57) ABSTRACT

A method comprises providing user playback information from a media player to a host computer, generating a program based on the playback information, and providing the program to the media player.

### BACKGROUND

Many media sources are available today. Examples of such media sources include live radio (e.g., FM radio, satellite radio, etc.) as well as downloadable media content such as “podcasts” and music files. A podcast generally refers to the distribution of multimedia files (e.g., audio programs, music videos, etc.), over the Internet, using a suitable format (e.g., RSS or Atom syndication formats) for playback on a variety of types of playback devices such as mobile devices and personal computers. The wide availability of such media sources is a double-edged sword. On one hand, the proliferation of available media sources advantageously provides the user with a tremendous number of options for his or her playback pleasure. On the other hand, finding and managing such content can be overwhelming and cumbersome for many users.

### BRIEF DESCRIPTION OF THE DRAWINGS

For a detailed description of exemplary embodiments of the invention, reference will now be made to the accompanying drawings in which:

FIG. 1 shows a system comprising a media player in accordance with an illustrative embodiment;

FIG. 2 shows an illustrative diagram of the media player of FIG. 1 in accordance with an embodiment, and

FIG. 3 shows a method performed by the system of FIG. 1 in accordance with an illustrative embodiment.

### DETAILED DESCRIPTION

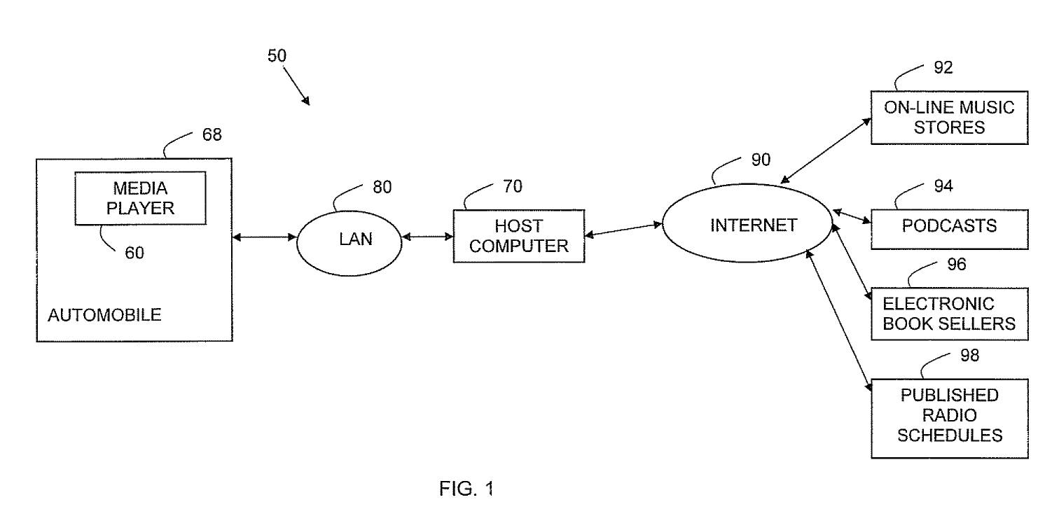

FIG. 1 shows an illustrative embodiment of a system comprising a media player. A system 50 is shown comprising a media player 60 operatively coupled to a host computer 70 via, for example, a local area network (LAN) 80. In the illustrative embodiment shown in FIG. 1, the media player 60 is located with an automobile 68. In some embodiments, the media player 60 is permanently installed in the automobile meaning that, while the media player could be removed, the media player is not intended to be forcibly removed on a normal usage basis. In other embodiments, the media player 60 is portable and is intended to be readily removed from the automobile 68 as desired. In yet other embodiments, the media player 60 is installed in vehicles or devices other than automobiles. In some embodiments, the media player 60 is portable and operatively usable without being installed in a vehicle or other device.

In some embodiments, the host computer 70 is located within a residence such as a house. In other embodiments, the host computer 70 is located within another type of structure such as an office building, theater, store, etc. That the host computer 70 is located within a structure is largely irrelevant to this disclosure.

The host computer 70 and media player 60 communicate with one another wirelessly in some embodiments, and via direct electrical connections in other embodiments. For example, if the house in which the host computer 70 is located includes the wireless LAN 80, then if the media player 60, or automobile 68 containing the media player, was located sufficiently close to the house, then the media player 60 would be able to “connect” to the host computer 70 via the LAN 80. For example, a user driving the automobile 68 into a garage of the house would permit the media player 60 and host computer 70 to communicate with one another. In other embodiments, the media player 60 is removed from the automobile 68 (to the extent the media player 60 was previously located within the automobile) and connected via, for example, a Universal Serial Bus (USB), or other type of electrical connection, to the host computer.

The media player 60 tracks (e.g., records) the user's playback behavior. The playback behavior characterizes how the user plays media content through the media player. Media content comprises audio, video, or a combination of audio and video. Examples of media content comprise one or more of podcasts, live radio broadcasts, and pre-stored music files, as well as additional or different types of content. The playback behavior tracked by the media player 60 comprises, for example, an identity of the content (e.g., podcast file name, radio station identifier, etc.) played back by the user of the media player. Another example of playback behavior is the order in which the content is played back. For example, the user may desire to listen to a daily podcast followed by live radio from a particular radio station followed by a particular genre of music (e.g., rock and roll, country, jazz). Another example of playback behavior comprises the amount of time each item of content is played through the media player 60.

The media player 60 tracks the playback behavior and stores information in the media player that defines the playback behavior. The playback behavior information is provided to the host computer 70 The host computer 70 examines the playback information to ascertain the content that the user has played. As will be described in more detail below, the host computer generates a program taking into account the user's playback behavior so as to create a new program for the user that the user would presumably desire (since the new program is based on the user's own previous listening behavior).

A program comprises at least one or more types of content from among podcasts, live radio broadcasts, and pre-stored music files. Additional or different types of media content can also be provided in the program. Some of the media content may already be stored on the host computer 70, while other of the media content is downloaded via the Internet 90 from one or more websites. Examples of such on-line sources of content include on-line music stores 92, podcast sources 94, electronic book sellers 96, and published radio schedules 98. In some embodiments, the program comprises a file that contains the items of content that the host computer 70 has selected to be part of the program. Live radio broadcasts are included in the program as an instruction to the media player to tune a radio receiver to the target station. In other embodiments, the program comprises multiple files. One file contains a list of the items of content to be played on the media player. The content items themselves are stored in a separate file or files. For example, each content item could individually be stored in a separate file.

The host computer 70 provides the program to the media player 60 via LAN 80. The media player 60 receives the program from the host computer and permits a user to select the program for playback.

The process by which the user's playback behavior is provided to, and used by, the host computer 70 to generate a new program can be performed in accordance with a programmed schedule, on demand (e.g., initiated by a user of the media player), or when the media player establishes communication with the host computer. In some embodiments, this process is repeated daily to provide an updated or new program to the media player 60 for the user's commute, such as to work or school. In other embodiments, the program generation process is performed whenever the media player 60 connects to (i.e., establishes communication with) the host computer. In some embodiments, the program generation process is performed whenever the media player 60 connects to the host computer as long as at least a predefined or programmable period of time has elapsed since the last program generation.

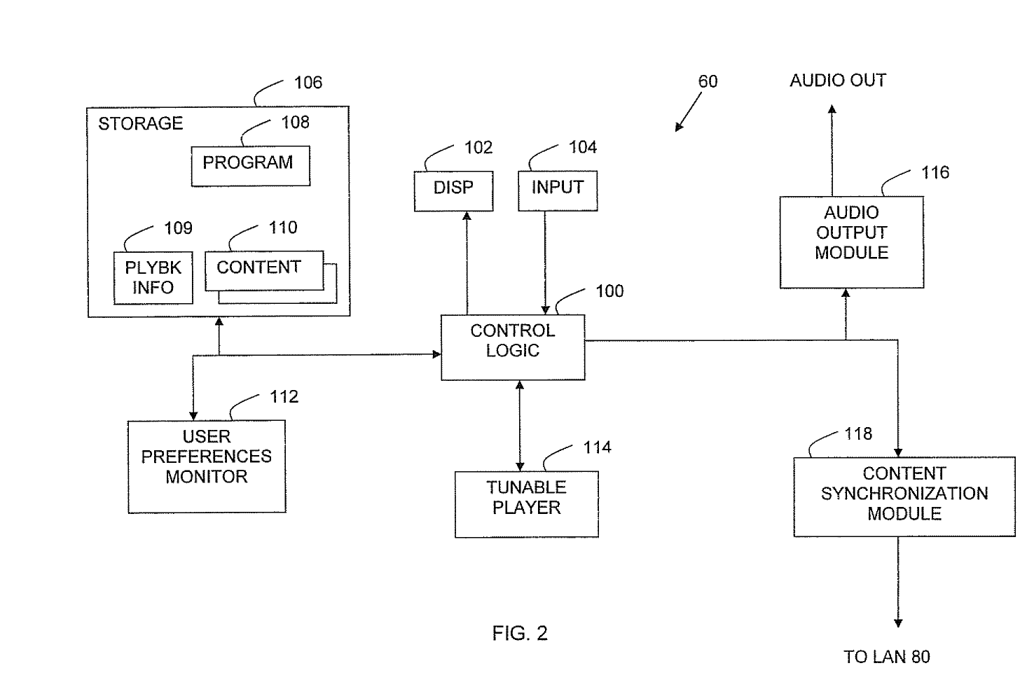

FIG. 2 shows an illustrative block diagram of the media player 60. As shown, the media player 60 comprises control logic 100, a display 102, an input device 104, storage 106, a user preferences monitor 112, a tunable player 114, an audio output module 116, and a content synchronization module 118. In some embodiments, the control logic 100 comprises a processor that executes codes The various components of the media player 60 can be coupled together as shown in FIG. 2 or in accordance with other configurations as desired. In some embodiments, the various components depicted in FIG. 2 may be separate components, while in other embodiments, various of the components may be integrated into a single module or circuit. Further still, some of the components may be implemented in hardware, software, or a combination of hardware and software. For example, the user preferences monitor may be implemented as a discrete circuit or as software executed by the control logic 100.

The display 102 comprises a liquid crystal display (LCD) or other suitable type of output device. The display 102 is used to provide, for example, media content selection choices to the user. The input device 104 comprises one or more user-activated buttons or other suitable type of user input control The user thereby interacts with the media player 60 via display 102 and input device 104 to select, for example, content to be played.

The storage 106 comprises volatile memory (e.g., random access memory), non-volatile storage (e.g., Flash memory, programmable read only memory, a hard drive, etc.), or combinations of volatile memory and non-volatile storage The programs generated by the host computer 70 are provided to the media player 60 and stored in storage 108 as programs 108. The programs may contain at least one of the items of content (except live broadcasts) At least one of the items of content may be stored separate from the program 108 in content storage 110. In such embodiments, the program 108 may specify (e.g., via a pointer such as a file name) a particular podcast that is to be played by the media player 60. The referenced podcast itself is stored as a file in content 110 in storage 106. In some embodiments the content 110 may originate from the program 108 downloaded from the host computer and/or may be stored on storage 106 separately by the user apart from receiving a program from the host computer 70.

In some embodiments, at the user's initiation via input 104, the control logic 100 causes the program 108 stored on storage 106 to be played by the media player 60. The media player 60 then begins to play the content referenced in the program 108 in the order specified in the program. During playback of the program 108, the user may desire to alter how the content is played back. For example, the user may choose to skip a particular content item, terminate the playing of that item before it completes, or alter the order by which the content is played back. Further still, the user may decide to play content available via the media player 60 that is not referenced in the media player's program 108. For example, the user might desire to interrupt the program-specified content to be played and, instead, play a live radio broadcast or music file that is not specified in the program. Unless the user intervenes, the control logic 100 will cause the media content specified by the program 108 to be played by or through the media player 60A.

Referring still to FIG. 2, the user preferences monitor 112 monitors the content that is played via the media player 60. The content that is played may or may not differ from that specified by the program 108. The content that is played will substantially match the program 108 if the user has not interfered with the playing of the program. On the other hand, the content that is played will deviate from that specified by the program 108 if the user has interfered with the playing of the program. The user preferences monitor stores playback information 109 (described above) in storage 106. Upon connection of the media player 60 with the host computer 70, the content synchronization module 118 causes the playback information 109 to be provided to the host computer 70 via LAN 80.

The tunable player 114 comprises a receiver that can be tuned to a desired station by control logic 100. The tunable player may comprise a frequency modulation (FM) radio receiver, an amplitude modulation (AM) radio receiver, a satellite receiver or any other type of playback device that can be tuned to a live broadcast signal. Via input device 104, for example, a user can specify particular radio station to which the control logic 100 tunes the tunable player 114.

Output audio electrical signals representing whatever content is being played by media player 60 are provided to, or generated by, the audio output module 116. The audio output module 116 can be coupled to an external audio system, such as an automobile's stereo system, so that the media content can be played through such an audio system. In some embodiments, the audio output module comprises a wireless transmitter, such as an FM transmitter, and wirelessly broadcasts the media content to be received by the automobile's FM radio receiver. In other embodiments, the audio output module 116 couples to one or more speakers and, in such embodiments, the audio output module 116 comprises an audio amplifier and drives such speakers.

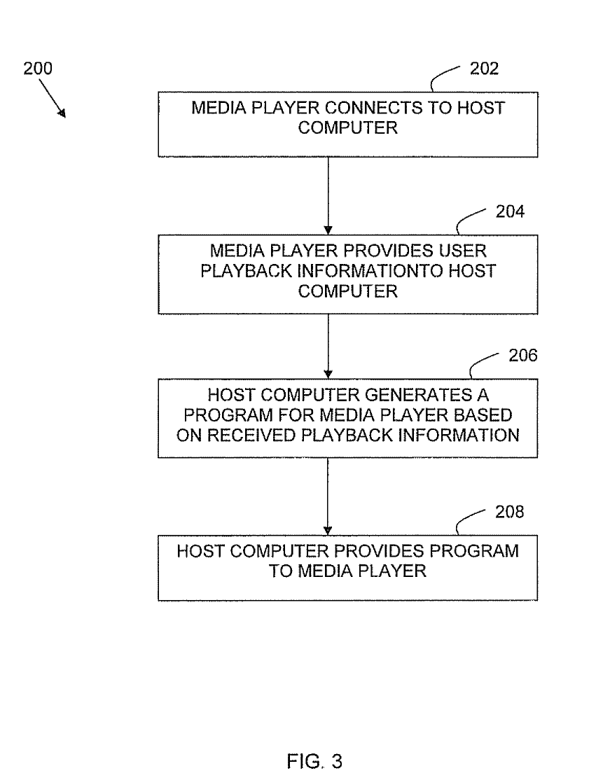

FIG. 3 shows a method 200 by which the host computer generates a new program based on the user's playback behavior monitored by the media player's user preferences monitor 112. At 202, the method comprises the media player 60 connecting to the host computer 70. At 204, the media player provides the user playback information 109 from storage 106 to the host computer. The host computer 70 then generates a program for the media player based on the received playback information, and at 208, the host computer transmits the newly generated program to the media player 60.

The host computer 70 generates the new program (206) in accordance with any of a variety of embodiments. For example, the host computer 70 may generate a program that exactly replicates the playback information. For example, if the playback information specifies that the user listened to 10 items of content (podcasts, live radio, etc.) in a particular order and each for a certain period of time, the host computer 70 generates a new program to replicate the user's listening experience. To the extent certain media content items have temporal significance, the host computer will download an updated version of such media content items. For example, if the user may have listened to a daily news report by podcast, the host computer 70 will download the next day's version of that news podcast. This means that generating the new program may or may not occur immediately upon receiving the user playback information (204) Instead, the host computer 70 may have to wait until the updated version of the desired media content is available to be downloaded. Each new program can be the same as, or different from, the previously generated program.

In some embodiments, a user of the host computer 70 can control the generation of the new program. That is, the user can modify the program (add content to, delete content from, etc.) otherwise automatically generated by the host computer 70. The first time a program is generated to be provided to the media player 68, the user manually selects the content for the initial program. Thus, in some embodiments, the program is generated exclusively or in part based on use input at the host computer 70.

In other embodiments, the host computer 70 retains (e.g., in its own storage) the previous n user playback information files, where n is a number equal to or greater than 1. The host computer 70 generates each successive program based on more than one playback information file. For example, the host computer may retain the previous 5 playback information files and generate a program based on the previous 5 playback information files. Further, the previous n playback information files can be weighted so as to favor more recently received playback information files but not completely ignore older playback information files. Accordingly, just because a user decides to skip playing a particular daily podcast on a particular day does not mean that the user would want that podcast to cease being part of the programs provided to it by the host computer. Thus, by taking into consideration more than just the past immediate playback information file, the host computer 70 will continue to include the podcast even if the user skips listening to it for one day. However, if the user skips listening to a particular media content item for more than one day (e.g., for more than n days), the host computer 70 will cease to include that particular content item in future programs.

In some embodiments, the media player 60 continuously monitors the user's playback behavior whenever the player 60 is powered on. In other embodiments, the user can selectively opt to cause the media player 60 to cease monitoring the playback behavior (e.g., via a user-activated control on the player).

The above discussion is meant to be illustrative of the principles and various embodiments of the present invention. Numerous variations and modifications will become apparent to those skilled in the art once the above disclosure is fully appreciated It is intended that the following claims be interpreted to embrace all such variations and modifications

What is claimed is:

1. A method, comprising,
providing user playback information from a media player to a host computer;
generating a program based on said playback information; and
providing said program to said media player.

2. The method of claim 1 further comprising connecting the media player to a networks

3. The method of claim 1 wherein providing user playback information from a media player to a host computer comprises wirelessly transmitting said playback information.

4. The method of claim 1 wherein providing said user playback information comprises providing information indicative of content to which a user of said media player listens.

5. The method of claim 1 wherein providing said user playback information comprises providing the order in which the user listens to said items.

6. The method of claim 5 wherein providing said user playback information also comprises providing information indicative of a plurality of items of content, said items of content comprise at least one of a podcast, a live radio broadcast, and a pre-stored music file.

7. The method of claim 1 wherein generating the program comprises generating a list of items of content in a particular order based on said playback information.

8. The method of claim 1 wherein generating the program comprises updating an immediately previous program generated.

9. The method of claim 1 wherein generating the program comprises generating a program based on playback information from more than one instance of playing media on said media player.

10. The method of claim 1 wherein generating the program comprises generating the program also based on user input at the host computer.

11. A media player, comprising:
control logic; and
a user preferences monitor coupled to said control logic;
wherein said user preferences monitor records identities of media content selected by a user of said media player.

12. The media player of claim 11 wherein said user preferences monitor also records an order in which the user selects said content to be played

13. The media player of claim 11 further comprising a content synchronization module coupled to said control logic, said content synchronization module causes said recorded identities to be transmitted to a host computer.

14. The media player of claim 13 wherein said content synchronization module causes said recorded identities to be wirelessly transmitted to said host computer.

15. The media player of claim 11 wherein said media player receives a program from a host computer, said program having been generated based on said recorded identities, and said program comprising at least one of a podcast, a live radio broadcast, and a pre-stored music file.

16. A computer-readable medium containing software that, when executed by a processor, causes the processor to:
receive a recorded list of identities of media content previously selected by a user to be played on a media player; and
based on said received recorded list, generate a program including a new list of identities of media content to be offered to the user to be played on said media player

17. The computer-readable medium of claim 16 wherein said software also causes said processor to cause said program to be provided to said media player.

18. The computer-readable medium of claim 16 wherein said software also causes said processor to download media content from a network based on said received recorded list of identities.

19. The computer-readable medium of claim 16 wherein downloaded media content comprises a podcast.

20. The computer-readable medium of claim 16 wherein said software causing said processor to generate the program comprises causing said processor to automatically download media content after said media content becomes available to be downloaded.
